(19) United States
(12) Patent Application Publication
(10) Pub. No.: US 2009/0325427 A1
(43) Pub. Date: Dec. 31, 2009

(54) Electrical Plug Connector Having Pretensioned Contact Plates

(76) Inventor: Eckhardt Philipp, Schwieberdingen (DE)

Correspondence Address: KENYON & KENYON LLP, ONE BROADWAY, NEW YORK, NY, 10004, US

(21) Appl. No.: 11/992,105

(22) PCT Filed: Aug. 4, 2006
(86) PCT No.: PCT/EP2006/065059

§ 371 Date: Aug. 12, 2009

(30) Foreign Application Priority Data
Sep. 14, 2005 (DE) 102005043692.7

(51) Int. Cl. H01R 13/10

(52) U.S. Cl. 439/856

(57) ABSTRACT

An electrical plug connector includes a socket provided for inserting an electrically conductive contact pin and formed by two parallel contact plates which are spaced a distance apart and extend from a base member counter to the plugging direction; the plug connector also includes at least one latching connection which maintains the contact plates in a pretensioned state with respect to one another and twisted in relation to the base member when the plug connector is in its initial state ready for insertion and which is releasable by inserting the contact pin.

### FIELD OF THE INVENTION

The present invention relates to an electrical plug connector having a socket provided for inserting an electrically conductive contact pin.

### BACKGROUND INFORMATION

Contact systems are known in the automobile sector in which contact plates are provided in a pretensioned state for plugging onto the contact pin. This pretensioning is achieved by deliberately bending back the contact plates from an initially overbent state and supporting them in this new position on a steel overspring via rigid supports. The pretensioning of the contact plates is intended to produce a large contact gap without reducing the normal contact forces active in the connected state, which are defined by the prebending state of the contact plates in the unloaded state. The advantage of a large contact gap set in this manner is the fact that the high frictional force at the beginning of plugging (connection peak in the plugging force path diagram) is substantially reduced, since the contact plates and the contact pin do not come into contact with each other until directly before the parallel area of the contact pin, i.e., in an area in which the sliding angles are more favorable in relation to the frictional forces. A large contact gap also reduces the probability of misalignment of the contact plates. In the case of known contact systems having pretensioned contact plates, the supports for pretensioning are rigid elements of the steel oversprings which limit the spring movement of the contact plates on one side, even in the connected state. Due to the narrow tolerances of such spring systems, there is the danger of the contact force not being completely reached or of the contact pin being contacted only on one side. Electrical plug connectors for vibration-proof plug connections are known, for example, from German Patent No. DE 200 06 550. Slidable electrical plug devices are also known from German Patent No. DE 195 11 225.

### SUMMARY OF THE INVENTION

The electrical plug connector according to the present invention has the advantage that, in their connected state, the contact plates are able to work over their entire spring area without being influenced by expansion elements. Due to the highly precise nature of the pretensioning setting, the connection peak during plugging is reduced to the level of the sliding frictional forces in the plateau area of the plugging force path curve. It may also be implemented in contact systems whose front contacting area is vibrationally decoupled from a crimping area and a steel overspring, since interactions with the surrounding elements of the contact are unnecessary in this system. In addition, a plug connector of this type may be manufactured within very narrow tolerances, since only punching/bending processes are used, and the precision of punching processes defines the gap dimension at this point.

### BRIEF DESCRIPTION OF THE DRAWINGS

FIG. 1 shows a perspective view of the plug connector according to the present invention in its initial state ready for the insertion of a contact pin.

FIG. 2 shows a sectional view of the plug connector according to II in FIG. 1 in its initial state as well as the associated assembly situation, in which the contact pin has not yet been inserted into the plug connector, in relation to a contact point of the plug connector.

FIG. 3 shows a sectional view of the plug connector as well as the associated assembly situation shortly before the contact pin comes into contact with the latching tabs of the plug connector, in a representation analogous to FIG. 2.

FIG. 4 shows a sectional view of the plug connector as well as the associated assembly situation when the latching tabs of the plug connector are partially spread apart by the inserted contact pin, in a representation analogous to FIG. 2.

FIG. 5 shows a sectional view of the plug connector as well as the associated assembly situation in the final state when the latching tabs of the plug connector are completely spread apart by the inserted contact pin, in a representation analogous to FIG. 2.

### DETAILED DESCRIPTION

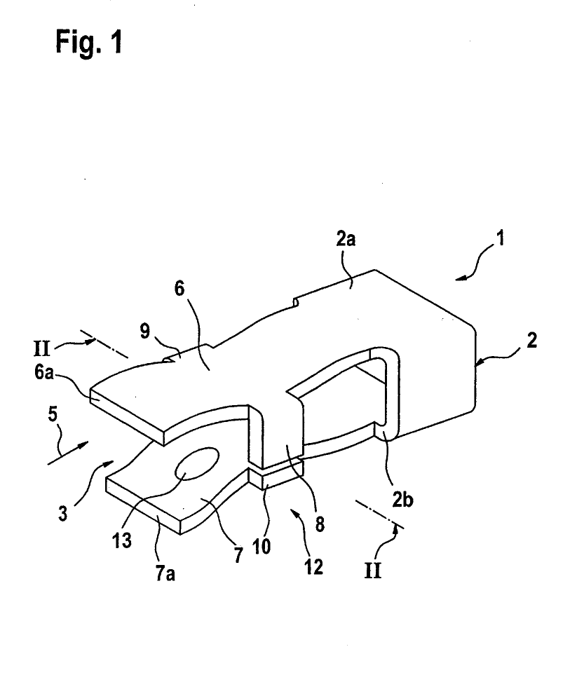

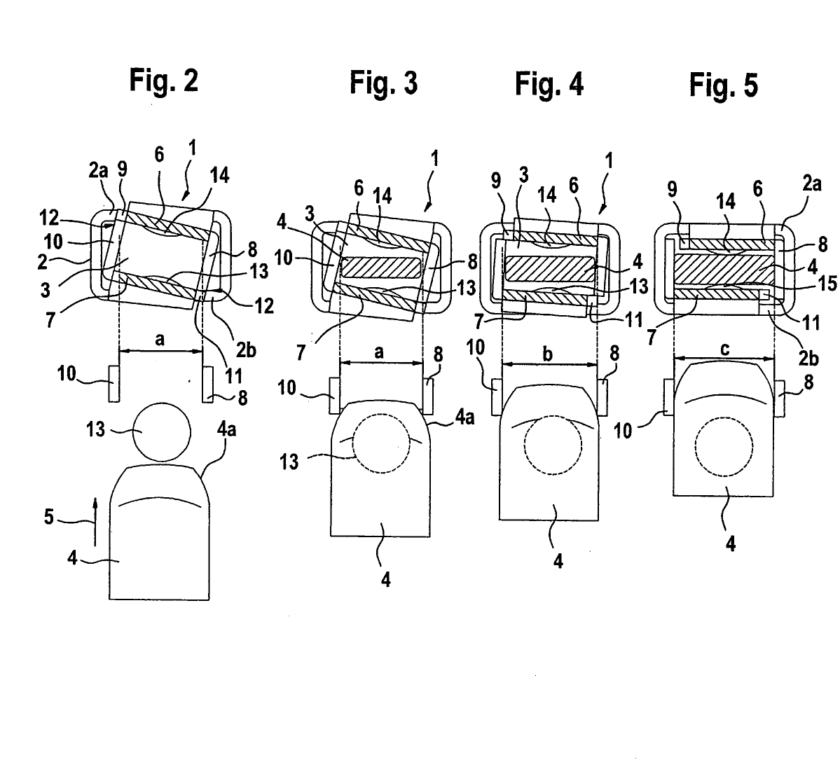

Electrical plug connector 1 illustrated in its initial state in FIG. 1 has a frame-shaped base member 2 and a socket 3 into which a flat contact pin 4 (FIG. 2) is insertable in plugging direction 5. Socket 3 is formed by two parallel tongue-shaped contact plates 6, 7, between which contact pin 4 is inserted into plug connector 1. The two contact plates 6, 7 are integrally connected to base member 2 at one end; namely, upper contact plate 6 in FIG. 1 is connected to upper frame leg 2a, and lower contact plate 7 is connected to lower frame leg 2b of base member 2, while free ends 6a, 7a of contact plates 6, 7 extend counter to plugging direction 5.

On its one side (the right side in FIG. 2) upper contact plate 6 has a laterally projecting latching tab 8 which is bent at a 90° angle from the plate plane in the direction of lower contact plate 7, and on its other (left) side, upper contact plate 6 has a supporting tab 9. Similarly, lower contact plate 7 has a laterally projecting latching tab 10 on its left side which is bent at a 90° angle from the plate plane in the direction of upper contact plate 6 and a supporting tab 11 on its right side. Plug connector 1 is preferably a stamped part made of an electrically conductive material such as iron, copper, brass, or alloys thereof.

In the initial state of plug connector 1, on the one hand, as shown in FIGS. 1 and 2, latching tabs 8, 10 are each supported on supporting tabs 9, 11 in a pretensioned manner and, on the other hand, as shown in FIG. 2, contact plates 6, 7 are twisted clockwise in a screw-like manner in the region of tabs 8 through 11 counter to their frame legs 2a, 2b, and are thus pretensioned in a counterclockwise direction in their position parallel to frame legs 2a, 2b. Latching and support tabs 8 through 11 each form a latching connection 12 on both sides of contact plates 6, 7 via which contact plates 6, 7 are pretensioned in a manner with respect to one another and counterclockwise to base member 2. Between supporting and latching tabs 8 through 11 and free ends 6a, 7a, contact plates 6, 7 each have on their facing inner sides a contact point 13, 14, which is designed as a raised mound-like contact dome and via which plug connector 1 contacts inserted contact pin 4. When the plug connector is in its initial state ready for insertion, the distance between contact plates 6, 7 is greater than the thickness of contact pin 4.

FIGS. 2 through 5 schematically illustrate the time sequence for inserting contact pin 4 into socket 3 of plug connector 1, the interaction between contact point 13 of lower contact plate 7 and contact pin 4 being illustrated schematically in the lower half of each figure in a schematic view seen from above.

In the initial position of plug connector 1 ready for insertion shown in FIG. 2, contact plates 6, 7 are maintained by the two latching connections 12 in a pretensioned state with respect to one another and twisted in relation to base member 2. The transverse distance between the two latching tabs 8, 10 is designated by reference letter a and is smaller than the width of contact pin 4, whose front plugging area 4a is tapered.

FIG. 3 shows plug connector 1 and contact pin 4, which is inserted into socket 3 and whose front plugging area 4a has not yet come into contact with latching tabs 8, 10 of plug connector 1. Contact pin 4 is not yet in contact with contact points 13, 14 of contact plates 6, 7.

FIG. 4 shows plug connector 1 and contact pin 4, which is inserted deeper into socket 3 and whose tapered front plugging area 4a has now been inserted between latching tabs 8, 10 of plug connector 1. As a result, latching tabs 8, 10 are spread toward one another in the transverse direction to a dimension b, but still rest on supporting tabs 9, 11. Contact pin 4 is not yet in contact with contact points 13, 14 of contact plates 6, 7.

Once supporting tabs 9, 11 have been fully spread to width c of contact pin 4 in the transverse direction, due to the further insertion of contact pin 4, latching tabs 8, 10 no longer rest on supporting tabs 9, 11. Latching connections 12 are released in such a way that the two contact plates 6, 7 both move toward one another and rotate back in a counterclockwise direction into their position parallel to frame legs 2a, 2b, due to their pretensioning. FIG. 5 shows plug connector 1 in this final state in which contact plates 6, 7 rest against contact pin 4 via their contact points 13, 14 and are oriented parallel to frame legs 2a, 2b.

In their receptive initial state, latching tabs 8, 10 may also be supported on contact plates 6, 7 instead of on laterally projecting supporting tabs 9, 11.

1-8. (canceled)

9. An electrical plug connector comprising:
a base member;
a socket for inserting an electrically conductive contact pin and being formed by two parallel contact plates which are spaced a distance apart and extend from the base member counter to a plugging direction; and
at least one latching connection which maintains the contact plates in a pretensioned state with respect to one another and twisted in relation to the base member when the plug connector is in its initial state ready for insertion and which is releasable by inserting the contact pin.

10. The plug connector according to claim 9, wherein a latching connection is situated on each side of the inserted contact pin.

11. The plug connector according to claim 9, wherein the latching connection is formed by a latching tab which is deflectably situated on one contact plate, is supported on the contact plate when the plug connector is in its initial state ready for insertion and projects into an insertion path of the contact pin.

12. The plug connector according to claim 11, wherein the latching tab situated on the one contact plate is bent in a direction of the other contact plate.

13. The plug connector according to claim 11, wherein the latching tab is deflectable from its supported latching position by the contact pin in a transverse direction.

14. The plug connector according to claim 11, wherein the latching tab situated on the one contact plate is supported on a laterally projecting supporting tab of the other contact plate when the plug connector is in the initial state ready for insertion.

15. The plug connector according to claim 9, wherein the contact plates have contact points on their inner sides facing one another for contacting the contact pin.

16. The plug connector according to claim 9, wherein the distance between the contact plates is greater than a thickness of the contact pin when the plug connector is in its initial state ready for insertion.
